(19) United States
(12) Patent Application Publication
(10) Pub. No.: US 2025/0293268 A1
(43) Pub. Date: Sep. 18, 2025

(54) CORE/SHELL CATALYSTS HAVING A PALLADIUM-CORE SURROUNDED BY A PLATINUM-SHELL FOR HIGH TEMPERATURE POLYMER EXCHANGE MEMBRANE FUEL CELLS

(71) Applicant: Toyota Motor Engineering & Manufacturing North America, Inc., Plano, TX (US)

(72) Inventors: Honghong Lin, Ann Arbor, MI (US); Siwen Wang, Livonia, MI (US); Chen Ling, Troy, MI (US); Gaohua Zhu, Ann Arbor, MI (US); Liang Wang, Saline, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/602,878

(22) Filed: Mar. 12, 2024

(51) Int. Cl. H01M 4/92; H01M 4/86; H01M 8/1213; H01M 8/124

(52) U.S. Cl. CPC H01M 4/921; H01M 4/8657; H01M 4/925; H01M 8/1213; H01M 8/124; H01M 2004/8689; H01M 2300/0082

(57) ABSTRACT

A core/shell catalyst, and, a phosphoric acid or a phosphonated ionomer contacting the core/shell catalyst in a fuel cell. The core/shell catalyst comprises a core surrounded by a shell, the core comprising palladium or a palladium-M1 alloy, the shell comprising a platinum-M2 alloy. M1 is chosen from scandium, titanium, vanadium, chromium, manganese, iron, cobalt, nickel, copper or zinc; and M2 is gold or silver. High-temperature polymer electrolyte membrane fuel cells (HT-PEMFCs, with phosphoric-acid-contained polymer matrix) employing a core/shell catalyst, and, a phosphoric acid or a phosphonated ionomer contacting the core/shell catalyst are disclosed.

### FIELD

The present disclosure generally relates to high temperature fuel cells having phosphoric acid or a phosphonated ionomer, and/or membrane electrode assemblies having a core/shell catalyst. In particular, a core/shell catalyst with a core having palladium or a palladium-M1 alloy surrounded by a platinum-M2 alloy shell, wherein M1 is scandium, titanium, vanadium, chromium, manganese, iron, cobalt, nickel, copper or zinc; and M2 is gold or silver is disclosed.

### BACKGROUND

The background description provided herein is for the purpose of generally presenting the context of the disclosure. Work of the presently named inventors, to the extent it may be described in this background section, as well as aspects of the description that may not otherwise qualify as prior art at the time of filing, are neither expressly nor implicitly admitted as prior art against the present technology.

Fuel cell vehicles (FCVs) are considered to be more efficient than conventional internal combustion engine vehicles and they have a zero emission powertrain platform. All current commercially available fuel cell vehicles use polymer electrolyte membrane fuel cells (PEMFCs), which include stacks of membrane electrode assemblies (MEAs). While PEMFC technology has been commercialized for decades, it still faces major challenges of high material costs and substantial performance gaps.

PEMFCs typically require efficient proton transport in their electrocatalyst layers in order to carry out the oxygen reduction reaction, and often underperform in very dry conditions due to poor proton transport in the absence of sufficient water. At the same time, excessive water can also impair performance. Moreover, the oxygen reduction reaction (ORR) that occurs at the cathode of PEMFCs has relatively slow chemical kinetics, thus posing an obstacle to cell performance. Even with a platinum catalyst, such cells typically suffer from significant overpotential loss and poor durability. Large amounts of catalysts are often used in order to overcome performance issues; however, this substantially increases cost. Efforts to decrease mass loading in PEMFC MEAs to lower costs have resulted in a decrease in high current density (HCD) performance.

Heavy duty vehicles (HDVs) generate more waste and require a higher temperature (>120° C.) compared to light-duty vehicles (LDVs) to meet the automotive heat rejection constraint. However, PEMFCs widely used in LDVs are not readily applied at a higher temperature because at temperatures above 100° C., proton conductivity decreases substantially as the membrane dehydrates.

The presence of phosphoric acid in PEMFC MEAs adversely affects the performance of the catalyst. Platinum is the most active monometallic element for oxygen reduction reactions. However, phosphoric acid poisoning of platinum group catalysts suppresses the oxygen reduction reaction (ORR) activity in high-temperature PEMFCs (HT-PEMFCs) due to competitive adsorption of phosphate on the platinum surface, which decreases the surface reactive site number on the platinum catalysts. On carbon-supported pure platinum (Pt/C), the phosphate competes with oxygen to adsorb onto the Pt site thereby decreasing the reaction sites for the ORR.

It would be desirable to develop improved catalysts and PEMFC catalyst layers having superior proton transport capability under varying humidity conditions, availability of active catalyst in the presence of phosphoric acid, improved function, and/or durability with lower cost.

### SUMMARY

This section provides a general summary of the disclosure and is not a comprehensive disclosure of its full scope or all of its features.

In various aspects, the present teachings provide an oxygen reduction reaction (ORR) catalyst comprising: a core/shell catalyst and a phosphoric acid or a phosphonated ionomer contacting-the core/shell catalyst. The core/shell catalyst comprises a core surrounded by a shell, the core comprising palladium or a palladium-M1 alloy, the shell comprising a platinum-M2 alloy. M1 is chosen from scandium, titanium, vanadium, chromium, manganese, iron, cobalt, nickel, copper, or zinc; and M2 is gold or silver.

The phosphonated ionomer can be poly(2,3,5,6-tetrafluorostyrene-4-phosphonic acid) (PWN) or poly(tetrafluorostyrene phosphonic acid-copentafluorostyrene) pSOL® (Fuel Cell Store).

In another aspect, the present disclosure provides a high temperature polymer electrolyte membrane fuel cell (HT-PEMFC) comprising an ORR catalyst and a phosphoric acid-contained polymer matrix in physical contact with the ORR catalyst. The ORR catalyst comprises: a core/shell catalyst and a phosphoric acid or a phosphonated ionomer contacting-the core/shell catalyst. The core/shell catalyst comprises a core surrounded by a shell, wherein the core comprising palladium or a palladium-M1 alloy, and the shell comprises a platinum-M2 alloy. M1 is chosen from scandium, titanium, vanadium, chromium, manganese, iron, cobalt, nickel, copper, or zinc; and M2 is gold or silver. The phosphoric acid-contained polymer matrix can be phosphoric acid-polybenzimidazole (PA-PBI) or phosphoric acid-doped ammonium-biphosphate ion pair coordinated polyphenylene (PA-QAPOH).

In another aspect, the present disclosure relates to a membrane electrode assembly (MEA) for a polymer electrolyte membrane fuel cell. The MEA comprises at least one catalyst layer which comprises a core/shell catalyst comprising a core surrounded by a shell, wherein the core comprises palladium or a palladium-M1 alloy, the shell comprising a platinum-M2 alloy-and a phosphoric acid or a phosphonated ionomer contacting-the core/shell catalyst. M1 is chosen from scandium, titanium, vanadium, chromium, manganese, iron, cobalt, nickel, copper, or zinc; and M2 is gold or silver.

In another aspect, the present disclosure relates to a membrane electrode assembly (MEA) for a polymer electrolyte membrane fuel cell, wherein the MEA comprises an anodic catalyst layer; a cathodic catalyst layer comprising carbon-supported cathodic catalyst particles of a core/shell catalyst, and a phosphoric acid or a phosphonated ionomer; and, a phosphoric acid-contained polymer matrix mediating protic communication between the anodic catalyst layer and the cathodic catalyst layer. The core/shell catalyst comprises a core surrounded by a shell, wherein the core comprises palladium or a palladium-M1 alloy, and the shell comprises a platinum-M2 alloy. M1 is chosen from scandium, titanium, vanadium, chromium, manganese, iron, cobalt, nickel, copper, or zinc; and M2 is gold or silver.

In yet another aspect, the present disclosure provides a polymer electrolyte membrane fuel cell (PEMFC) comprising a membrane electrode assembly (MEA). Each MEA comprises: comprises an anodic catalyst layer; a cathodic catalyst layer comprising carbon-supported cathodic catalyst particles of a core/shell catalyst, and a phosphoric acid or a phosphonated ionomer; and, a phosphoric acid-contained polymer matrix mediating protic communication between the anodic catalyst layer and the cathodic catalyst layer. The core/shell catalyst comprises a core surrounded by a shell, wherein the core comprises palladium or a palladium-M1 alloy, and the shell comprises a platinum-M2 alloy. M1 is chosen from scandium, titanium, vanadium, chromium, manganese, iron, cobalt, nickel, copper, or zinc; and M2 is gold or silver.

The PEMFC can be a high temperature PEMFC (HT-PEMFC) operating at a temperature ranging from about 80° C. to about 230° C.

In these different aspects, the core/shell catalyst can comprise nanoparticles of the core/shell catalyst. In the core/shell catalyst, the core is palladium or a palladium alloy and the shell is a platinum-gold alloy or a platinum-silver alloy. The core/shell catalyst can be at a cathode. The shape of the core/shell catalyst is polyhedral, nanorod, nanowire, nanoplate or nanosheet. The core/shell catalyst may have a compressive strain ranging from about −0.06 to about 0.00. The catalyst can also include phosphoric acid in contact with the core/shell catalyst. The catalyst can also include a phosphonated ionomer in contact with the core/shell catalyst. The catalyst can also include a phosphoric acid-contained polymer matrix in physical contact with the core/shell catalyst. The ORR is performed at a temperature ranging from about 80° C. to about 230° C.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF DRAWINGS

The present teachings will become more fully understood from the detailed description and the accompanying drawings wherein:

FIG. 1 is a schematic cross-sectional view of an example of a membrane electrode assembly (MEA) of the present disclosure.

FIG. 2 is a schematic cross-sectional view of a portion of an exemplary fuel cell of the present disclosure.

FIG. 3 is a schematic cross-sectional view of a portion of an exemplary fuel cell of the present disclosure.

FIG. 4A is a graph demonstrating the results of a room temperature rotating disk electrode (RT-RDE) study of ORR specific activity (amperes/meter² platinum surface area or A/m² Pt) comparing Pt/C, Pt—Fe/C, Pt—Co/C, Pt—Ni/C, Pt—Ru/C, Pt—Pd/C and Pt—Ir/C nanoparticle catalysts in the absence of phosphoric acid (specific activity observed in a reaction in 0.1 M HClO₄; filled circles) or in the presence of phosphoric acid (specific activity observed in reaction in 0.1 M HClO₄ and 0.1 M H₃PO₄ multiplied by a factor of ten; open circles) at room temperature.

FIG. 4B is a graph demonstrating the results of a comparison of oxygen (O) adsorption area retention % (open circles) and ORR activity retention % trend (shown as room temperature specific activity (RT-SA); filled circles) of Pt/C, Pt—Fe/C, Pt—Co/C, Pt—Ni/C, Pt—Ru/C, Pt—Pd/C and Pt—Ir/C bimetallic alloy catalysts in the absence of phosphoric acid (reaction in 0.1 M HClO₄) and in the presence of phosphoric acid (reaction in 0.1 M HClO₄+0.1 M H₃PO₄).

FIG. 4C is a graph demonstrating the results of a comparison of ORR specific activity (A/m² Pt) of Pt/C, Pt—Fe/C, Pt—Co/C, Pt—Ni/C, Pt—Ru/C, Pt—Pd/C and Pt—Ir/C in the presence of phosphoric acid at room temperature from a RT-RDE study (reaction in 0.1 M HClO₄+0.1 M H₃PO₄) at about 25° C. and at about 0.9 V (RT in FIG. 4C) and in the presence of concentrated phosphoric acid at a higher temperature from HT-RDE study at about 160° C. and at about 0.82 V (HT in FIG. 4C).

FIG. 5A is a schematic illustration of a core/shell nanoparticle catalyst having a polyhedral shape with Pd or Pd-M1 alloy core encapsulated by a Pt-M2 shell, wherein M1 is a first-row transition metal (Sc, Ti, V, Cr, Mn, Fe, Co, Ni, Cu or Zn) and M2 is gold or silver. D is diameter of the core/shell catalyst in nanometers and S is thickness of the shell in nanometers. The polyhedral is chosen from spherical, cubic, tetrahedral, octahedral, dodecahedral, icosahedral or cuboctahedral and such other geometric shapes.

FIG. 5B is a schematic illustration of a one dimensional (1D) core/shell nanoparticle catalyst having a nanorod or nanowire shape with Pd or Pd-M1 alloy core encapsulated by a Pt-M2 shell, wherein M1 is a first-row transition metal (Sc, Ti, V, Cr, Mn, Fe, Co, Ni, Cu or Zn) and M2 is gold or silver.

FIG. 5C is a schematic illustration of a two dimensional (2D) core/shell nanoparticle catalyst having a nanoplate or nanosheet shape with Pd or Pd-M1 alloy core encapsulated by a Pt-M2 shell, wherein M1 is a first-row transition metal (Sc, Ti, V, Cr, Mn, Fe, Co, Ni, Cu or Zn) and M2 is gold or silver.

FIG. 6 is a graph showing the phosphate (PA) binding energy (electron volts or eV) of Pt₁M₁(111) relative to Pt(111) for Pt—Fe/C, Pt—Co/C, Pt—Ni/C, Pt—Cu/C, Pt—Ru/C, Pt—Pd/C, Pt—Ag/C, Pt—Ir/C and Pt—Au/C.

FIG. 7 is a graph showing the relative binding energy (eV) of groups *OH (closed circles), *OOH (open triangles) and *HPO₄ (closed inverted triangles) adsorbed to a Pt(111) surface when different compressive strain was applied to an unstrained Pt(111) surface.

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific examples within the scope of this technology. Further, certain aspects may incorporate features from a combination of figures.

### DESCRIPTION

The present teachings describe a core/shell catalyst for a fuel cell having a phosphoric acid as the electrolyte. A core/shell catalyst comprises a core surrounded by a shell, wherein the core comprises palladium or a palladium-M1 alloy, and the shell comprises a platinum-M2 alloy. M1 is chosen from scandium, titanium, vanadium, chromium, manganese, iron, cobalt, nickel, copper, or zinc; and M2 is gold or silver. An oxygen reduction reaction (ORR) with a core/shell catalyst contacted by the phosphoric acid and incorporated at the cathode of a fuel cell is expected to exhibit superior ORR activity at a high temperature as compared to ORR activity at room temperature in the presence of phosphoric acid.

High temperature polymer exchange membrane fuel cells (HT-PEMFCs) (80-230° C.) have a major difference with low temperature PEMFCs in the proton carrier. To overcome the poor conductivity of the perfluorinated sulfonic acid polymer under dry conditions, HT-PEMFCs use phosphoric acid to transport protons. Phosphoric acid can adsorb onto the Pt surface and block the active sites for the oxygen reduction reaction (ORR), suppressing the activity.

The present inventors identified two factors that contributed to a high ORR activity of bimetallic platinum alloy catalysts in phosphoric acid: (1) a high intrinsic ORR activity, and (2) a high resistance to phosphoric acid adsorption. The disclosed core/shell catalyst of the present disclosure wherein the core is surrounded by a shell incorporates both these positive factors to improve the ORR activity. The core/shell catalyst can alternatively be considered as the core being encompassed, or encased, or encapsulated by the shell.

ORR catalysts of the present teachings include a core/shell catalyst; and, a phosphoric acid or a phosphonated ionomer contacting the core/shell catalyst. The core/shell catalyst comprises a core surrounded by a shell, wherein the core comprises palladium or a palladium-M1 alloy, and the shell comprises a platinum-M2 alloy. M1 is chosen from scandium, titanium, vanadium, chromium, manganese, iron, cobalt, nickel, copper, or zinc; and M2 is gold or silver. ORR catalysts can include nanoparticles of the core/shell catalyst. The nanoparticles may be contacted by the aforementioned phosphoric acid or a phosphonated ionomer resulting in superior activity and stability. The ORR catalyst may be further contacted by a phosphoric acid-contained polymer matrix resulting in superior activity and stability.

Thus, a catalyst composition for catalyzing ORR (referred to alternatively as an ORR catalyst) in a PEMFC is disclosed. In some examples, the catalyst composition will have particles of a core/shell catalyst. The catalytic metal particles can be nanoparticles, such as nanoparticles of a core/shell catalyst. The core/shell catalyst comprises a core encompassed by a shell, the core comprising palladium or a palladium-M1 alloy, the shell comprising a platinum-M2 alloy. M1 is chosen from scandium, titanium, vanadium, chromium, manganese, iron, cobalt, nickel, copper, or zinc; and M2 is gold or silver.

In some examples, the catalyst will include particles of a catalytic core/shell catalyst in admixture with particles of another material, such as carbon, which can be selected from carbon black, graphite, activated carbon, and carbon nanotubes. The core/shell catalyst comprises a core encased by a shell, wherein the core comprises palladium or a palladium-M1 alloy, and the shell comprises a platinum-M2 alloy. M1 is chosen from scandium, titanium, vanadium, chromium, manganese, iron, cobalt, nickel, copper, or zinc; and M2 is gold or silver.

The size and shape of the catalytic core/shell particles can be optimized to maximize total surface area of the catalyst and reaction sites available to participate in the reactions per volume of catalyst used. In some examples, the particles of a catalytic core/shell catalyst will have a specific surface area of about 10 m²/g to about 300 m²/g, about 50 m²/g to about 200 m²/g, about 100 m²/g to about 150 m²/g, at least 10 m²/g, or 20 m²/g, or 30 m²/g, or 40 m²/g, or 50 m²/g, or 60 m²/g, or 70 m²/g, or 80 m²/g, or 90 m²/g, or 100 m²/g, or 110 m²/g, or 120 m²/g, or 130 m²/g, or 140 m²/g, or 150 m²/g, or 160 m²/g, or 170 m²/g, or 180 m²/g, or 190 m²/g, or 200 m²/g, or 210 m²/g, or 220 m²/g, or 230 m²/g, or 240 m²/g, or 250 m²/g, or 260 m²/g, or 270 m²/g or 280 m²/g, or 290 m²/g, or 300 m²/g. In some examples, the particles of a catalytic core/shell will be nanoparticles having an average maximum dimension of about 1 nanometer to about 1 micrometer, about 100 nanometers to about 900 nanometers, about 200 nanometers to about 800 nanometers, about 300 nanometers to about 700 nanometers, about 400 nanometers to about 600 nanometers, about 400 nanometers to about 500 nanometers, about 1 nanometer to about 100 nanometers, about 20 nanometers to about 90 nanometers, about 30 nanometers to about 80 nanometers, about 40 nanometers to about 60 nanometers, about 40 nanometers to about 50 nanometers, about 1 nanometer to about 10 nanometers, about 2 nanometers to about 9 nanometers, about 3 nanometers to about 7 nanometers, about 4 nanometers to about 6 nanometers, less than 1 micrometer, less than 900 nm, less than 800 nm, less than 700 nm, less than 600 nm, less than 500 nm, less than 400 nm, less than 300 nm, less than 200 nm, less than 100 nm, or less than 90 nm, or less than 80 nm, or less than 70 nm, or less than 60 nm, or less than 50 nm, or less than 40 nm, or less than 30 nm, or less than 20 nm, or less than 10 nm. In some examples, the catalyst composition will include core/shell nanoparticles having an average maximum dimension of about 2 nanometers to about 5 nm in diameter. In some examples, the diameter of the particles of the catalytic core/shell will range from about 2 nm to about 20 nm or about 3 nm to about 19 nm, or about 4 nm to about 18 nm, or about 5 nm to about 17 nm, or about 6 nm to about 16 nm, or about 7 nm to about 15 nm, or about 8 nm to about 14 nm, or about 9 nm to about 13 nm, or about 10 nm to about 12 nm, or about 10 nm to about 11 nm, or about 2 nm, or about 3 nm, or about 4 nm, or about 5 nm, or about 6 nm, or about 7 nm, or about 8 nm, or about 9 nm, or about 10 nm, or about 11 nm, or about 12 nm, or about 13 nm, or about 14 nm, or about 15 nm, or about 16 nm, or about 17 nm, or about 18 nm, or about 19 nm, or about 20 nm. In some examples the thickness of the shell will be about 3 to about 5 atomic-layers thick. In some examples, the width of the shell will be about 0.3 nm to about 2 nm, or about 0.5 nm to about 1.5 nm, or about 0.8 nm to about 1.2 nm, or about 2 nm, or less than about 2 nanometers, or about 1.9 nm, or about 1.8 nm, or about 1.7 nm, or about 1.6 nm, or about 1.5 nm, or about 1.4 nm, or about 1.3 nm, or about 1.2 nm, or about 1.1 nm, or about 1.0 nm, or about 0.9 nm, or about 0.8 nm, or about 0.7 nm, or about 0.6 nm, or about 0.5 nm, or about 0.4 nm, or about 0.3 nm.

In some examples, the particles of a catalytic core/shell will include continuous, smooth, nonporous particles.

The shape of the catalytic core/shell nanoparticles can be polyhedral, nanorod, nanowire, nanoplate or nanosheet. The polyhedral shape of the catalytic core/shell particles can be spherical, cubic, octahedral, cube, tetrahedral, dodecahedral, icosahedral, or cuboctahedral or other geometric shapes.

Compressive strain on the core/shell catalyst surface is the deformation or compression experienced by the shell of the core/shell catalyst. Compressive strain is introduced in the shell of the disclosed core/shell catalysts because palladium or a palladium-M1 alloy in the core has a smaller lattice constant than the platinum-M2 alloy in the shell. M1 is chosen from scandium, titanium, vanadium, chromium, manganese, iron, cobalt, nickel, copper, or zinc; and M2 is gold or silver. The compressive strain can be varied in the disclosed core/shell catalysts by varying the content of palladium or the transition metal alloyed with palladium in the core. In some examples, the core/shell catalyst may have a compressive strain ranging from about −0.06 to about 0.00, or about −0.05 to 0.00 or about −0.04 to about 0.00. An oxygen reduction reaction (ORR) with a core/shell catalyst having higher compressive strain when contacted by the phosphoric acid and incorporated at the cathode of a fuel cell is expected to exhibit superior ORR activity at a high temperature as compared to ORR activity by a core/shell catalyst having lesser compressive strain at a high temperature in the presence of phosphoric acid.

When a catalyst particle is contacting phosphoric acid or a phosphonated ionomer, a catalyst of core/shell nanoparticles improves ORR activity, and MEA performance as discussed further below. The core/shell catalyst comprises a core encapsulated by a shell, wherein the core comprises a palladium or a palladium-M1 alloy, and the shell comprises a platinum-M2 alloy. M1 is chosen from scandium, titanium, vanadium, chromium, manganese, iron, cobalt, nickel, copper, or zinc; and M2 is gold or silver.

In certain examples discussed herein, the core/shell catalyst will include a mixture of the core/shell and carbon particles. In some examples, the catalyst composition can also include a phosphoric acid-contained (PA) polymer matrix, such as phosphoric acid doped-pyridine containing aromatic polyether membranes, for example, ammonium-biphosphate ion pair coordinated polyphenylene (PA-QAPOH) contacting the core/shell catalyst. In some examples, the catalyst composition can also include a phosphoric acid-contained polymer matrix, such as polybenzimidazole (PBI) contacting the core/shell catalyst.

In some examples, catalyst compositions of the present disclosure will have Au or Ag present at a weight ratio relative to the shell of the core/shell catalyst within a range of about 1% to about 50%, or about 1% to about 45%, or about 1% to about 40%, or about 1% to about 30%, or about 1% to about 20%, or about 1% to about 10%, or about 10% to about 50%, or about 20% to about 40%, or about 25% to about 30%, or about 1%, or about 5%, or about 10%, or about 15%, or about 20%, or about 25%, or about 30%, or about 35%, or about 40%, or about 45%, or about 50% by weight. In some examples of catalyst compositions of the present disclosure, Pt will be present at a weight ratio relative to the shell of the core/shell catalyst within a range of about 50% to about 99%, or about 60% to about 80%, or about 65% to about 75%, or about 50%, or about 55%, or about 60% or about 65% or about 70% or about 75% or about 80%, or about 85%, or about 90%, or about 95%, or about 99% by weight. In some examples, catalyst compositions of the present disclosure will have a core of pure Pd in the core/shell catalyst, or have Pd at a weight ratio relative to the core of the core/shell catalyst of about 100%, or 100% by weight. In some examples, catalyst compositions of the present disclosure having Pd-M1 alloy will have Pd present at a weight ratio relative to the core of the core/shell catalyst within a range of about 10% to about 90%, or about 20% to about 80%, or about 30% to about 70%, or about 40% to about 60%, or about 45% to about 55%, about 10%, about 20%, or about 30%, about 40%, or about 50%, or about 60%, or about 70%, or about 80% or about 90% by weight. In some examples, catalyst compositions of the present disclosure having Pd-M1 alloy will have a first row transition metal (Sc, Ti, V, Cr, Mn, Fe, Co, Ni, Cu or Zn) present at a weight ratio relative to the core of the core/shell catalyst within a range of about 10% to about 90%, or about 20% to about 80%, or about 30% to about 70%, or about 40% to about 60%, or about 45% to about 55%, or about 10%, or about 20%, or about 30%, or about 40%, or about 50%, or about 60%, or about 70%, or about 80%, or about 90% by weight. In some examples, particles of the core/shell catalyst will be fully coated by the phosphoric acid, and in other examples, particles of the core/shell catalyst will be partially coated by the phosphoric acid.

MEAs of the present disclosure include electrodes having composites comprising the core/shell catalyst and a phosphoric acid. The composite of the present disclosure provides enhanced performance of the MEA. More specifically, the composite of the present disclosure comprises the core/shell catalyst of the present disclosure (or as described herein, etc.); and a phosphoric acid or a phosphonated ionomer contacting the core/shell catalyst.

In some examples, a phosphonated ionomer is in physical contact with the core/shell catalyst. One example of an ionomer is a phosphonated poly(pentafluorostyrene) (PWN). Other examples include pSOL® ionomer (poly(tetrafluorostyrene phosphonic acid-copentafluorostyrene)) available from Fuel Cell Store.

In some examples, a phosphoric acid-contained polymer matrix is in physical contact with the core/shell catalyst. The presence of a phosphoric acid-contained polymer matrix acts as a protonic bridge between the membrane and catalyst surface as well as a binder for a carbon supported catalyst.

Phosphoric acid-contained polymer matrix that can be employed in examples of the present disclosure include ammonium-biphosphate ion pair coordinated polyphenylene (PA-QAPOH), phosphoric acid-polybenzimidazole and phosphoric-acid polybenzimidazole derived polymers.

A phosphoric acid doping percentage in the phosphoric acid-contained polymer matrix can be about 0 to 50 mg/cm². In some examples, the phosphoric acid can be substituted with a highly conductive phosphonated ionomer. The phosphoric acid doping percentage should be high enough to allow protons to pass but not so high to cause flooding and catalyst poisoning.

The present disclosure also includes membrane electrode assemblies (MEAs) for polymer electrolyte membrane fuel cells (PEMFCs). MEAs of the present teachings include electrodes having composites of a core/shell catalyst, and phosphoric acid or a phosphonated ionomer. The disclosed MEAs can exhibit notably superior performance and improved proton transportation as compared to MEAs lacking phosphoric acid or phosphonated ionomer.

MEAs of the present teachings include a composite cathode having a cathode catalyst mixed with a phosphoric acid or a phosphonated ionomer. The catalyst is a core/shell. The composite cathode improves MEA performance in both low and high humidity.

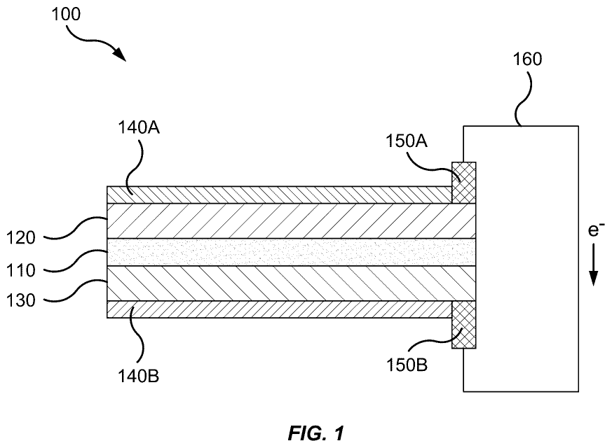

FIG. 1 shows a schematic cross-sectional view of an exemplary, disclosed MEA 100 for a PEMFC. The MEA 100 includes a polymer electrolyte membrane (PEM) 110 configured to support proton transfer (i.e., proton conduction) across the membrane, and to be electrically insulative. The PEM 110 can be a pure polymer membrane or a composite membrane, and can be formed of any suitable material, such as a phosphoric acid containing polymer matrix or a phosphonated polymer or any other suitable material. The MEA 100 further includes an anodic catalyst layer 120, configured to electrolytically catalyze an anodic hydrogen-splitting reaction: H₂→2e⁻+2H⁺.

The anodic catalyst layer can be substantially formed of anodic catalyst particles of platinum, or a platinum alloy supported on carbon, such as carbon black.

The MEA 100 further includes a cathodic catalyst layer 130, configured to catalyze an oxygen reduction reaction: O₂+4e⁻+4H⁺→2H₂O.

The cathodic catalyst layer 130 can include cathodic catalyst particles of a core/shell catalyst or a core/shell catalyst supported on carbon, such as carbon black. The cathodic catalyst will typically further include a phosphoric acid or a phosphonated ionomer in admixture with the carbon-supported cathodic catalyst particles.

In some examples, the anodic catalyst layer 120 and/or the cathodic catalyst layer 130 can include a phosphoric acid or phosphonated ionomer. In some examples, the anodic catalyst layer 120 and/or the cathodic catalyst layer 130 can include a solid ionomer, such as a fluorinated polymer, e.g., NAFION®. In some examples, the anodic catalyst layer 120 can include platinum (whether present unalloyed or in an alloy) at a loading density of about 0.05 to about 1.0 mg Pt/cm²; and the cathodic catalyst layer 130 can include core/shell at a loading density within a range of from about 0.0.5 to about 1.0 mg Pt/cm², inclusive. In some examples, the weight ratio of ionic liquid to carbon-supported cathodic catalyst particles can be about 1:10.

It will be understood that the phosphoric acid-contained polymer matrix places the anodic catalyst layer 120 and the cathodic catalyst layer in protic communication with one another. The MEA 100 can include first and second gas diffusion layers 140A, 140B in contact with the anodic catalyst layer 120 and the cathodic catalyst layer 130, respectively. The first and second gas diffusion layers 140A, 140B are configured to allow hydrogen and oxygen gas to diffuse to the anodic and cathodic catalyst layers, 120, 130, respectively, and to allow water product to diffuse away from the cathodic catalyst layer 130. The MEA 100 can further include anodic and cathodic current collectors 150A, 150B, configured to be in electric communication with the anodic and cathodic catalyst layers 120, 130, respectively, and to connect to be connected to an external circuit 160.

In some examples, the ORR catalyst composition can also include a polymeric ionomer, such as NAFION® (DuPont), a perfluorosulfonic acid (PFSA) contacting the core/shell catalyst. Other commercially available examples include FLEMION® (Asahi Glass Company) ACIPLEX® (Asahi Kasei), Aquivion® (Solvay) and FUMION® (FuMA-Tech).

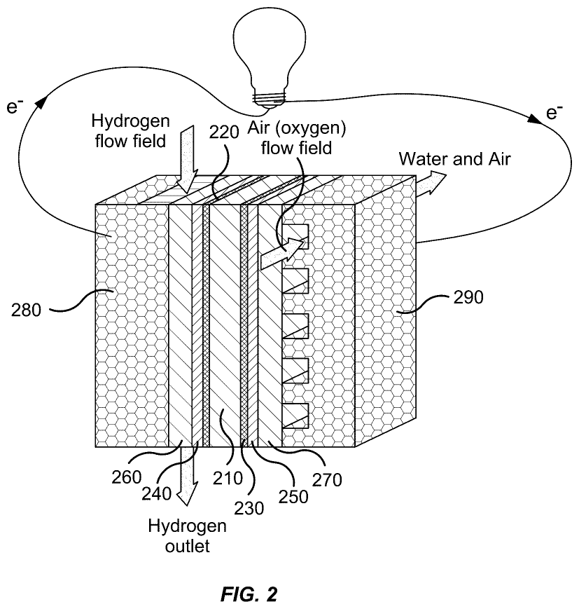

FIG. 2 illustrates an example of a fuel cell 200 having a phosphoric acid-contained polymer matrix 210, an anodic catalytic layer 220 and a cathodic catalytic layer 230. An anode microporous layer 240 contacts the anodic catalytic layer 220. An anode gas diffusion layer 260 contacts the anode microporous layer 240. A cathode microporous layer 250 contacts the cathodic catalytic layer 230. A cathode gas diffusion layer 270 contacts the cathode microporous layer 250. An anode bipolar plate 280 contacts the anode gas diffusion layer 260 and a cathode bipolar plate 290 contacts the cathode gas diffusion layer 270. Hydrogen and air flow within the cell is pictured in FIG. 2. Hydrogen (H₂) is fed to the anode side of the fuel cell and an oxygen source (such as ambient air) is fed to the cathode side of the fuel cell. In FIG. 2, water and excess air are depicted as exiting the cathode side of the fuel cell and unreacted hydrogen is shown as exiting the anode side of the fuel cell.

The anode bipolar plate 280 and the cathode bipolar plate 290 can independently be made from a metal (such as titanium or stainless steel), or a carbon structure (such as graphite). Some metal bipolar plates use a carbon film coating on some or all surfaces of the bipolar plate. U.S. Pat. No. 10,283,785, incorporated herein by reference, teaches use of an amorphous carbon film in bipolar plates. In the fuel cell, the fuel gas and the oxygen gas should be separately supplied to the entire electrode surfaces without being mixed with each other. Therefore, the bipolar plates should be gas tight. Furthermore, the bipolar plates should collect electrons generated by the reaction and have good electric conductivity in order to serve as electric connectors for connecting adjoining single cells when a plurality of single cells are stacked. Moreover, because electrolyte membrane surfaces are strongly acidic, the bipolar plates provide good corrosion resistance. The main purpose of bipolar plate to fulfill in PEMFC stack is to supply fuel (hydrogen) and oxygen to the cell and also to manage heat produced and water flow. It is also used as a backing medium for stacking of individual fuel cells.

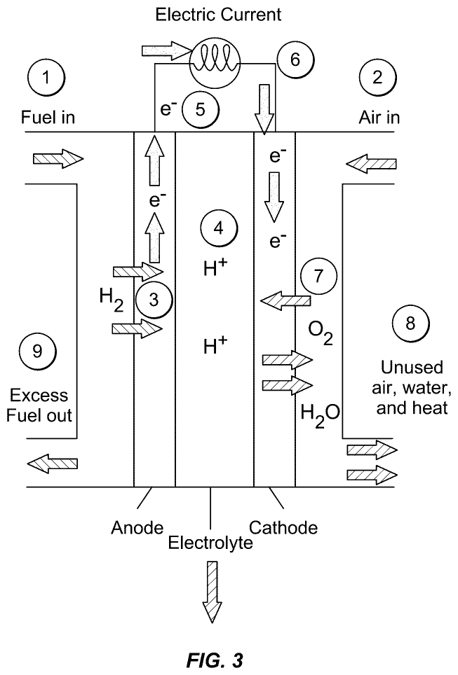

FIG. 3 illustrates how a PEMFC works. At 1, pure hydrogen from the fuel tank or onboard reformer is fueled from the anode side while at 2 oxygen from air is injected from the cathode side with the help of bipolar plates on both sides (not shown). At 3, at the anode, the hydrogen molecule is split into hydrogen ions (protons) and electrons. At 4, the hydrogen ions permeate across the electrolyte to the cathode while at 5 the electrons are forced out of the anode and produce electric current at 6 that flows to the cathode through the external load and produce electric power. At 7, oxygen, usually in the form of air, is supplied to the cathode and combines with the electrons and the hydrogen ions to produce water. Unused air, water, and heat exit on the cathode side at 8 and excess fuel exits out the anode side at 9.

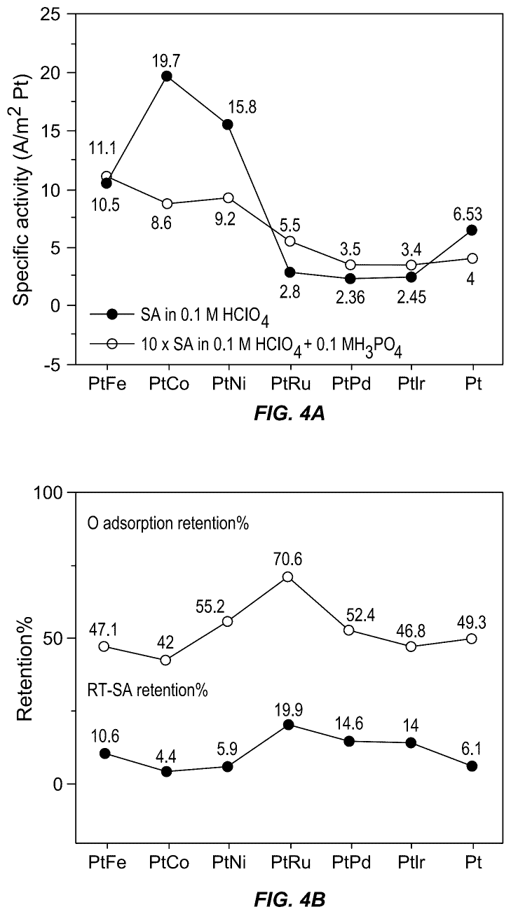

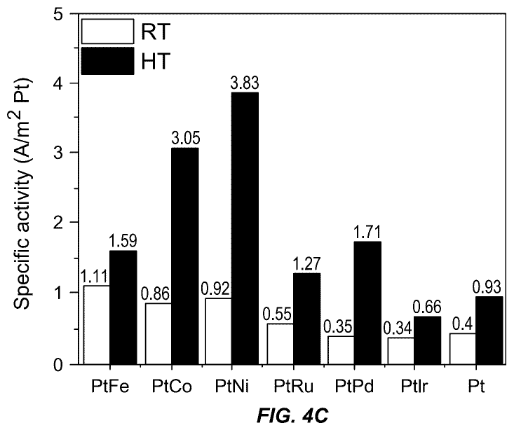

FIGS. 4A, 4B and 4C show that higher ORR activity of bimetallic platinum alloy catalysts occurred in phosphoric acid when the bimetallic platinum alloy catalysts had high intrinsic ORR activity and a high resistance to phosphoric acid adsorption.

FIG. 4A shows room temperature rotating disk electrode (RT-RDE) study comparison of ORR specific activity (A/m² Pt) of platinum alone and carbon supported bimetallic alloys of platinum with metals, such as, Fe, Co, Ni, Ru, Pd or Ir in the absence of phosphoric acid (reaction in 0.1 M HClO₄; filled circles) at room temperature 25° C. and in the presence of phosphoric acid (reaction in 0.1 M HClO₄ and 0.1 M H₃PO₄, results multiplied by 10; open circles). In FIG. 4A, carbon supported platinum alloys with Fe, Co, Ni which show higher ORR activity in 0.1 M HClO₄ also showed higher activity in 0.1 M HClO₄+0.1 M H₃PO₄. Therefore, the activity of these alloys was not affected by H₃PO₄ poisoning. The ORR activity in 0.1 M HClO₄ alone (in the absence of H₃PO₄) is referred to herein as “intrinsic activity” to distinguish it from the activity observed in the presence of H₃PO₄. Pt—Fe/C, Pt—Co/C and Pt—Ni/C alloy catalysts in phosphoric acid show higher ORR activity than a pure Pt/C catalyst in phosphoric acid at room temperature and at high temperature.

FIG. 4B is a graph showing the results of oxygen (O) adsorption area retention (open circles) and ORR activity retention trend (closed circles; room temperature specific activity (RT-SA)) for reaction in absence of phosphoric acid in 0.1 M HClO₄ and reaction in presence of phosphoric acid in 0.1 M HClO₄+0.1 M H₃PO₄ for bimetallic catalysts Pt/C, Pt—Fe/C, Pt—Co/C, Pt—Ni/C, Pt—Ru/C, Pt—Pd/C and Pt—Ir/C. Oxygen adsorption retention %=(value of oxygen adsorption in 0.1 M HClO₄/value of oxygen adsorption in 0.1 M HClO₄+0.1 M H₃PO₄)×100%. Oxygen adsorption retention % indicates the percentage of oxygen molecules that remained adsorbed (or attached) to the surface of the bimetallic catalyst and efficiency of the bimetallic catalyst in adsorbing and retaining oxygen. The open circles show the O adsorption area change in presence of phosphoric acid where the more positive the O adsorption retention % indicated that more active sites were retained on the catalyst surface. The catalyst PtPd and PtRu, despite the low intrinsic ORR activity in absence of phosphoric acid (as seen in FIG. 4A), showed a high O area retention in presence of phosphoric acid (FIG. 4B). RT-SA retention percentage refers to the percentage of a specific activity of the bimetallic catalyst that is retained when ORR activity is performed at room temperature. RT-SA retention %=(value of ORR specific activity in 0.1 M HClO₄/value of ORR specific activity in 0.1 M HClO₄+0.1 M H₃PO₄)×100%. FIG. 4B showed a direct correlation relationship between oxygen adsorption retention % and RT-SA retention %. For example, Pt—Ru catalyst which had a higher oxygen adsorption retention % than Pt—Ni showed a correspondingly higher RT-SA retention % compared to Pt—Ni.

FIG. 4C shows comparison of ORR specific activity (A/m² Pt) of Pt/C, Pt—Fe/C, Pt—Co/C, Pt—Ni/C, Pt—Ru/C, Pt—Pd/C and Pt—Ir/C and in presence of phosphoric acid at room temperature from RT-RDE study (reaction in 0.1 M HClO₄+0.1 M H₃PO₄) at about 25° C. and at about 0.9 V (RT in FIG. 4C) and in the presence of concentrated phosphoric acid at higher temperature from HT-RDE study at about 160° C. and at about 0.82 V (HT in FIG. 4C). The results showed lesser suppression of ORR activity by phosphoric acid at a higher temperature as compared to room temperature. The catalyst Pt—Pd/C and Pt—Ru/C, despite the low intrinsic ORR activity (as seen in FIG. 4A), showed a high O area retention (FIG. 4B) and a high ORR activity (as shown in FIG. 4C).

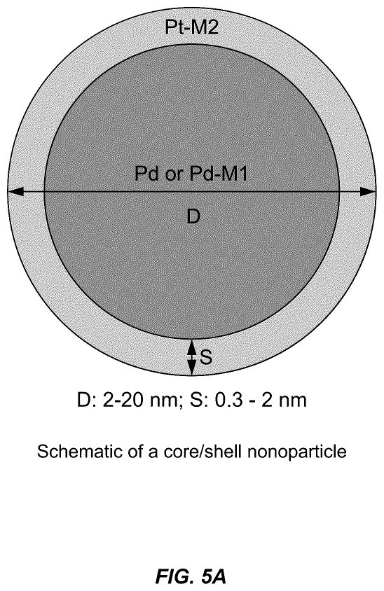

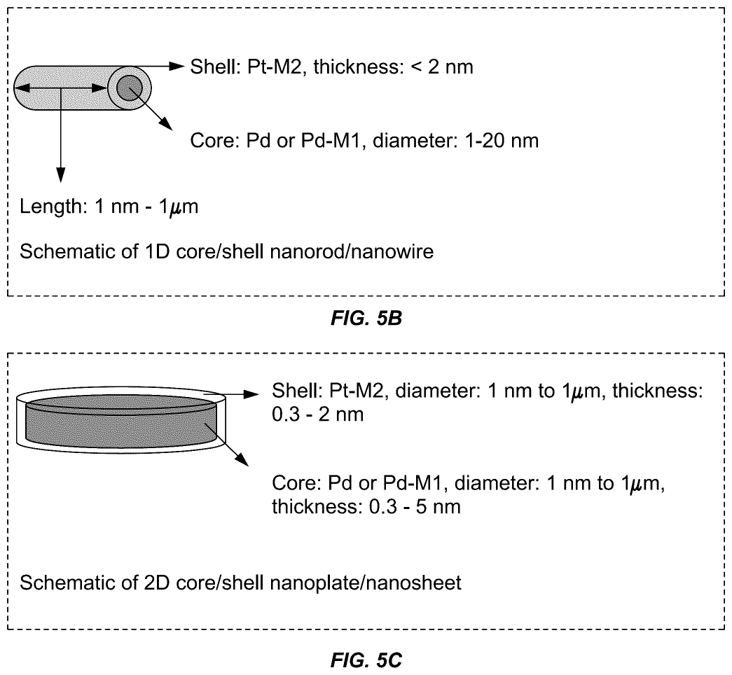

FIGS. 5A, 5B and 5C show schematics core/shell catalyst nanoparticles with various nanostructures that adds a phosphoric acid anti-poisoning feature and compressive strain to the surface of the catalyst. In the core/shell catalysts, the phosphoric acid adsorption on the surface of the catalyst is weakened by adding Au and thereby more active Pt sites would be available for ORR in phosphoric acid leading to improved HT-PEMFC performance. The shell composition includes Pt-M2, wherein M2 is Au (gold) or Ag (silver). In a core/shell catalyst having a Pt—Au shell, Au ranges from about 1% to about 50% by weight of the shell of the core/shell catalyst and Pt in the shell ranges from about 50 to about 99% by weight. In a core/shell catalyst having Pt—Ag, Ag ranges from about 1% to about 50% by weight of the shell of the core/shell catalyst and Pt in the shell ranges from about 50% to about 99%. The core is made of Pd or Pd-M1 alloy with a first-row transition metals (Sc, Ti, V, Cr, Mn, Fe, Co, Ni, Cu or Zn). Pd ranges from about 10% to about 90% by weight of core of a core/shell catalyst having Pd-M1 alloy. The first row transition metal in the core ranges from about 10% to about 90% by weight of the core of a core/shell catalyst having Pd-M1 alloy. The percentages provided for each component of the composition of the core/shell catalysts is the atomic ratio, for example, Pt50Au50, Pt51Au49 etc., or for example Pd10Sc90, Pd11Sc89 etc.

In the schematic of the core/shell nanoparticle in FIG. 5A, the diameter (D) of the core/shell catalyst ranges from about 2 nm to about 20 nm. The thickness of the shell(S) is 0.3 to 2 nm. The shape of the core/shell catalyst is polyhedral. The polyhedral is chosen from spherical, cubic, tetrahedral, octahedral, dodecahedral, icosahedral or cuboctahedral and other geometric shapes. The catalyst can be used for HT-PEMFCs with phosphoric acid or organic phosphonic acid electrolyte.

In the schematic of the one dimensional (1D) nanorod or nanowire shape of the core/shell catalyst in FIG. 5B, the thickness of the shell is less than 2 nm, the diameter of the core ranges from 1 nm to 20 nm, and length of the nanorod or nanowire ranges from 1 nm to 1 μm. The catalyst can be used for HT-PEMFCs with phosphoric acid or organic phosphonic acid electrolyte.

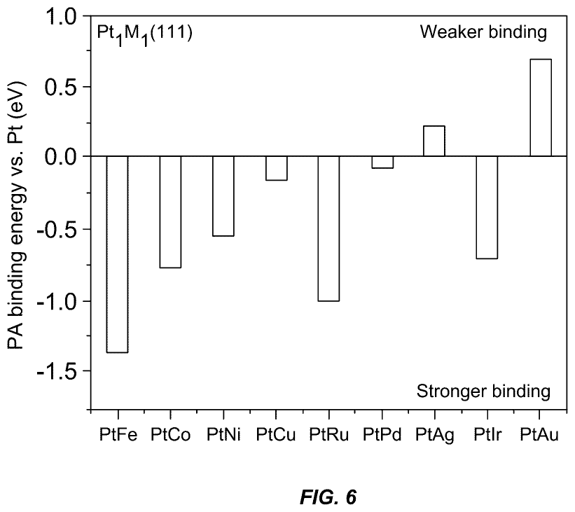

In the schematic of the two dimensional (2D) shape of the core.shell catalyst in FIG. 5C, the diameter of the shell ranges from 1 nm to 1 μm, thickness of the shell ranges from 0.3 to 2 nm. The diameter of the core ranges from 1 nm to 1 μm and thickness of the core ranges from 0.3 to 5 nm. The catalyst can be used for HT-PEMFCs with phosphoric acid or organic phosphonic acid electrolyte. FIG. 6 shows density-function theory (DFT) simulation. DFT simulations assist in predicting the catalytic activity of materials used for ORR activity. In FIG. 6, the y-axis represents the binding energy of phosphate with Pt₁M₁(111) relative to that of Pt(111) in electron Volts (eV). “Pt(111)” describes a platinum surface that is oriented along the (111) crystallographic plane. (111) refers to the Miller indices of the plane. The Miller indices are a set of three integers (h, k, l) used to describe the orientation of crystal planes in a crystal lattice. For the (111) plane, h=1, k=1, and l=1. Pt1 indicates the presence of platinum (Pt) with a subscript “1” denoting a single layer or monolayer of platinum. M1 indicates the presence of metal (M) with a subscript “1” denoting a single layer or monolayer of metal. Pt1M1(111) suggests that the layers of Pt and M are oriented along the (111) plane. In DFT analysis, the more positive binding energy indicates the weaker the adsorption. As shown in FIG. 6, Au stands out among the series of transition metals because Pt—Au bimetallic alloy had the weakest phosphate binding energy as compared to Pt—Fe, Pt—Co, Pt—Ni, Pt—Cu, Pt—Pd, Pt—Ag and Pt—Ir. Pt—Ag also had weaker binding energy as compared to Pt—Fe, Pt—Co, Pt—Ni, Pt—Cu, Pt—Pd, and Pt—Ir.

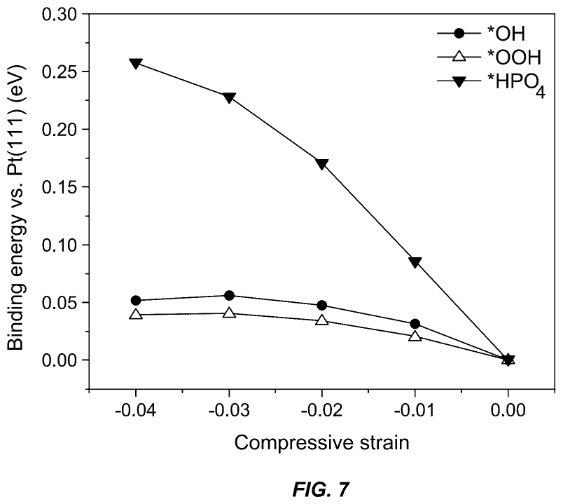

FIG. 7 shows the relative binding energy (eV) of the adsorbed groups on the surface of a Pt(111) skin subjected to compressive strain ranging from −0.04 to 0.00. The relative binding energy is the PA binding energy on compressed Pt(111) surface relative to normal Pt(111) surface. It was found that applying a compressive strain on Pt(111) manifested a more significant weakening effect on phosphoric acid and oxygenated intermediates (*OH (closed circles), *OOH (open triangles) and *HPO₄ (closed inverted triangles)). Other studies observed that a compressed Pt skin shows higher ORR activity. By making the core component have a smaller lattice constant, the shell of a disclosed core/shell catalyst as in FIGS. 5A, 5B and 5C will experience a compressive strain and have a reduced Pt—Pt distance, which can reduce H₃PO₄ poisoning and facilitate intrinsic ORR activity at the same time.

Based on results from FIGS. 6 and 7 it is expected that core/shell catalysts of the present disclosure would have superior or enhanced ORR activity in the presence of phosphoric acid at a high temperature as compared to ORR activity at low temperature. Although other studies showed that Au was not favorable for ORR catalysis, DFT simulations in FIG. 6 showed that phosphoric acid adsorption would be significantly weaker on a Pt—Au surface or a Pt—Ag surface than on a pure Pt surface. Therefore, the disclosed core/shell catalysts having a platinum alloy shell with gold or silver are expected to decrease H₃PO₄ poisoning which would enhance ORR activity in the presence of phosphoric acid as compared to ORR activity of a core/shell catalyst with a pure platinum shell. Further, compressive shells are known to facilitate intrinsic ORR activity in the absence of phosphoric acid. FIG. 7 shows that a compressive shell can be created by a core having palladium or a palladium alloy. The disclosed core/shell catalysts are expected to have enhanced intrinsic ORR activity because of the compressive strain introduced by the palladium or a palladium alloy core as compared to a core/shell catalyst that does not have palladium or palladium alloy core. FIG. 4C showed that those carbon supported bimetallic Pt catalysts (such as PtFe/C, PtCo/C and PtNi/C) that had a high intrinsic ORR activity (in absence of phosphoric acid) at room temperature as seen in FIG. 4A also exhibited higher ORR activity in the presence of phosphoric acid at high temperature as compared to ORR activity at room temperature in the presence of phosphoric acid. Therefore, the increased intrinsic ORR activity expected in the disclosed core/shell catalysts because of compressive strain by the core having palladium or palladium alloy is expected to enhance ORR activity at a high temperature in the presence of phosphoric acid as compared to a core/shell catalyst without compressive strain at room temperature in the presence of phosphoric acid. Therefore, the disclosed core/shell catalysts are expected to enhance ORR activity in the presence of phosphoric acid at a high temperature because of features that are expected to decrease H₃PO₄ poisoning and increase compressive strain.

### EXAMPLES

Various aspects of the present disclosure are further illustrated with respect to the following examples. It is to be understood that these examples are provided to illustrate specific examples of the present disclosure and should not be construed as limiting the scope of the present disclosure in or to any particular aspect.

### Example 1. Room Temperature Rotating Disk Electrode (RT-RDE) Experiment

Three-electrode cell components and conditioning protocols were prepared as described in Nagai, T., Jahn, C., and Jia, H. (2019). Improved Accelerated Stress Tests for ORR Catalysts Using a Rotating Disk Electrode. J. Electrochem. Soc. 166, F3111-F3115. 10.1149/2.0161907jes. In brief, the catalyst ink was prepared by mixing the catalyst with 25 vol % 2-propanol aqueous solution and 5 wt % NAFION® solution. The mixture was sonicated in an ice bath for 60 min to get uniform dispersion. 10 μL of the catalyst ink was pipetted on a clean glassy carbon disk electrode (GC, 5 mm in diameter) and dried in air at room temperature by using an inverted rotator at 200 rpm. The NAFION® to carbon ratio was 0.5. The catalyst loading on the electrode was 15 ug Pt/cm².

### Example 2. High Temperature Rotating Disk Electrode (HT-RDE) Experiment

The cell component was the same as the RT-RDE setup in Example 1. An oil bath was used to heat the cell, and a thermometer isolated in a glass tube was used to monitor the temperature. 10 μL of the catalyst ink was pipetted on a clean glassy carbon disk electrode (GC, 5 mm in diameter) and dried in air at room temperature by using an inverted rotator at 200 rpm. The NAFION® to carbon ratio was 0.9. The catalyst loading on the electrode was 60 ug Pt/cm².

### Example 3. Density Functional Analysis

Density functional theory (DFT) calculations were performed on Pt/C, Pt—Fe, Pt—Co, Pt—Ni, Pt—Cu, Pt—Pd, Pt—Ir, Pt—Au and Pt—Ag in phosphoric acid as described in Lin et al. (Honghong Lin, Zhendong Hu, Katie H. Lim, Siwen Wang, Li Qin Zhou, Liang Wang, Gaohua Zhu, Keiichi Okubo, Chen Ling, Yu Seung Kim, and Hongfei Jia, High-Temperature Rotating Disk Electrode Study of Platinum Bimetallic Catalysts in Phosphoric Acid, ACS Catal. 2023, 13, 5635-5642), incorporated herein by reference.

The present disclosure can be applicable to various other aspects, such as a vehicle driven by utilizing electric power of the fuel cell, a power generation system that supplies electric power of the fuel cell, and other articles comprising the fuel cells. In some examples, the vehicle can be a passenger car or truck. In some examples the power generation system can be stationary. The present disclosure is not limited to the above aspects or examples but can be implemented by any of various other aspects or examples within the scope of the disclosure.

Further, the disclosure comprises additional notes and examples as detailed below.

Clause 1. An oxygen reduction reaction (ORR) catalyst comprising: a core/shell catalyst comprising a core surrounded by a shell, the core comprising palladium or a palladium-M1 alloy, the shell comprising a platinum-M2 alloy; and,
a phosphoric acid or a phosphonated ionomer contacting the core/shell catalyst, wherein M1 is chosen from scandium, titanium, vanadium, chromium, manganese, iron, cobalt, nickel, copper or zinc; and M2 is gold or silver.

Clause 3. The ORR catalyst of any one of clauses 1 to 2, wherein the core/shell catalyst comprises nanoparticles of the core/shell catalyst.

Clause 4. The ORR catalyst of any of clauses 1 to 3, wherein the core/shell catalyst is at a cathode.

Clause 5. The ORR catalyst of any of clauses 1 to 4, wherein a shape of the core/shell catalyst is chosen from polyhedral, nanorod, nanowire, nanoplate and nanosheet.

Clause 6. The ORR catalyst of any of clauses 1 to 5, wherein the polyhedral is chosen from spherical, cubic, tetrahedral, octahedral, dodecahedral, icosahedral or cuboctahedral.

Clause 7. The ORR catalyst of any of clauses 1 to 6, wherein the core/shell catalyst has a compressive strain ranging from about-0.06 to about 0.00.

Clause 8. The ORR catalyst of any of clauses 1 to 7, wherein the core/shell catalyst has a compressive strain ranging from about −0.05 to about 0.00.

Clause 9. The ORR catalyst of any of clauses 1 to 8, wherein the core/shell catalyst has a compressive strain ranging from about −0.04 to about 0.00.

Clause 10. The ORR catalyst of any of clauses 1 to 9, wherein the shell is about 3 to about 5 atomic layers thick.

Clause 11. The ORR catalyst of any of clauses 1 to 10, wherein the width of the shell is less than about 2 nanometers.

Clause 12. The ORR catalyst of any of clauses 1 to 11, wherein the width of the shell is about 0.3 nm to about 2 nm.

Clause 13. The ORR catalyst of any of clauses 1 to 12, wherein the width of the shell is about 0.5 nm to about 1.5 nm.

Clause 14. The ORR catalyst of any of clauses 1 to 13, wherein the width of the shell is about 0.8 nm to about 1.2 nm.

Clause 15. The ORR catalyst of any of clauses 1 to 14, wherein a particle size of the core/shell catalyst ranges from about 2 nm to about 20 nm.

Clause 16. The ORR catalyst of any of clauses 1 to 15, wherein gold in the core/shell catalyst ranges from about 1% to about 50% by weight.

Clause 17. The ORR catalyst of any of clauses 1 to 16, wherein palladium in the core/shell catalyst ranges from about 10% to about 90% by weight.

Clause 18. The ORR catalyst of any of clauses 1 to 17, wherein an ORR is performed at a temperature ranging from about 80° C. to about 230° C.

Clause 19. The ORR catalyst of any of clauses 1 to 18, wherein the phosphonated ionomer is poly(2,3,5,6-tetrafluorostyrene-4-phosphonic acid) (PWN) or poly(tetraflurostyrene phosphonic acid-copentafluorostyrene).

Clause 20. A high-temperature polymer electrolyte membrane fuel cell (HT-PEMFC) comprising the ORR catalyst of any of clauses 1 to 14 and a phosphoric acid-contained polymer matrix, wherein the phosphoric acid-contained polymer matrix is in physical contact with the ORR catalyst.

Clause 21. The HT-PEMFC of clause 20, wherein the phosphoric acid-contained polymer matrix is a phosphoric acid-polybenzimidazole (PA-PBI) or a phosphoric acid-doped ammonium-biphosphate ion pair coordinated polyphenylene (PA-QAPOH).

Clause 22. A membrane electrode assembly (MEA), the MEA comprising:
at least one catalyst layer which comprises a core/shell catalyst, and,
a phosphoric acid or a phosphonated ionomer,
the core/shell catalyst comprising a core surrounded by a shell, the core comprising palladium or a palladium-M1 alloy, the shell comprising a platinum-M2 alloy; and,
a phosphoric acid or a phosphonated ionomer contacting the core/shell catalyst,
wherein M1 is chosen from scandium, titanium, vanadium, chromium, manganese, iron, cobalt, nickel, copper or zinc; and M2 is gold or silver.

Clause 23. The MEA of clause 22, wherein core/shell catalyst comprises nanoparticles of the core/shell catalyst.

Clause 24. The MEA of any of clauses 22 and 23, wherein the core/shell catalyst is at a cathode.

Clause 25. The MEA of any of clauses 22 to 24, further comprising a phosphoric acid-contained polymer matrix in physical contact with the core/shell catalyst.

Clause 26. The MEA of any of clauses 22 to 25, wherein the phosphoric acid-contained polymer matrix is a phosphoric acid-doped polybenzimidazole (PA-PBI) or a phosphoric acid-doped ammonium-biphosphate ion pair coordinated polyphenylene (PA-QAPOH).

Clause 27. The MEA of any of clauses 22 to 26, wherein the phosphonated ionomer is poly(2,3,5,6-tetrafluorostyrene-4-phosphonic acid) (PWN) or poly(tetraflurostyrene phosphonic acid-copentafluorostyrene).

Clause 28. A HT-PEMFC comprising the MEA of any of clauses 22 to 27, wherein an ORR is performed at a temperature ranging from about 80° C. to about 230° C.

Clause 29. A membrane electrode assembly (MEA), the MEA comprising:
an anodic catalyst layer;
a cathodic catalyst layer comprising carbon supported cathodic catalyst particles of a core/shell catalyst, and, a phosphoric acid or a phosphonated ionomer; and,
a phosphoric acid-contained polymer matrix mediating protic communication between the anodic catalyst layer and the cathodic catalyst layer,
the core/shell catalyst comprising a core surrounded by a shell, the core comprising palladium or a palladium-M1 alloy, the shell comprising a platinum-M2 alloy; and,
a phosphoric acid or a phosphonated ionomer contacting the core/shell catalyst,
wherein M1 is chosen from scandium, titanium, vanadium, chromium, manganese, iron, cobalt, nickel, copper or zinc; and M2 is gold or silver.

Clause 30. The MEA of clause 29, wherein the cathodic catalyst particles are nanoparticles of the core/shell catalyst.

Clause 31. The MEA of any of clauses 29 to 30, wherein the phosphoric acid-contained polymer matrix is a phosphoric acid-doped polybenzimidazole (PA-PBI) or a phosphoric acid-doped ammonium-biphosphate ion pair coordinated polyphenylene (PA-QAPOH).

Clause 32. The MEA of any of clauses 29 to 31, wherein the phosphonated ionomer is poly(2,3,5,6-tetrafluorostyrene-4-phosphonic acid) (PWN) or poly(tetraflurostyrene phosphonic acid-copentafluorostyrene).

Clause 33. A HT-PEMFC comprising the MEA according to any of clauses 29 to 32.

Clause 34. A composite cathode having a cathode catalyst mixed with phosphoric acid.

Clause 35. The composite cathode catalyst of clause 34, comprising a core/shell.

Clause 36. A composite cathode having a cathode catalyst mixed with a phosphonated ionomer.

Clause 37. The composite cathode catalyst of clause 36, comprising a core/shell.

Clause 38. A HT-PEMFC comprising an oxygen reduction reaction (ORR) catalyst, wherein the ORR catalyst comprises: a core/shell; and, a phosphoric acid or a phosphonated ionomer contacting the core/shell catalyst.

Clause 39. A HT-PEMFC comprising an anodic catalyst layer, a cathodic catalyst layer and a phosphoric acid-contained polymer matrix, wherein the cathode catalyst layer comprises a carbon-supported core/shell catalyst and a phosphoric acid.

Clause 40. The HT-PEMFC of clause 39, wherein the phosphoric acid-contained polymer matrix is a phosphoric acid doped-pyridine containing aromatic polyether membrane, a phosphoric acid-doped polybenzimidazole (PA-PBI), or a phosphoric acid-doped ammonium-biphosphate ion pair coordinated polyphenylene (PA-QAPOH).

Clause 41. A HT-PEMFC comprising an anodic catalyst layer, a cathodic catalyst layer and a phosphoric acid-contained polymer matrix, wherein the cathode catalyst layer comprises a carbon-supported core/shell catalyst and a phosphonated ionomer.

Clause 42. The HT-PEMFC of clause 41, wherein the phosphoric acid-contained polymer matrix is a phosphoric acid doped-pyridine containing aromatic polyether membrane, a phosphoric acid-doped polybenzimidazole (PA-PBI), or a phosphoric acid-doped ammonium-biphosphate ion pair coordinated polyphenylene (PA-QAPOH).

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple examples having stated features is not intended to exclude other embodiments having additional features, or other examples incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an example can or may comprise certain elements or features does not exclude other examples of the present technology that do not contain those elements or features.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. An oxygen reduction reaction (ORR) catalyst comprising:
a core/shell catalyst comprising a core surrounded by a shell, wherein the core comprises palladium or a palladium-M1 alloy, and the shell comprises a platinum-M2 alloy; and,
a phosphoric acid or a phosphonated ionomer contacting the core/shell catalyst,
wherein M1 is chosen from scandium, titanium, vanadium, chromium, manganese, iron, cobalt, nickel, copper or zinc; and M2 is gold or silver.

2. The ORR catalyst of claim 1, wherein the core/shell catalyst comprises nanoparticles of the core/shell catalyst.

3. The ORR catalyst of claim 1, wherein the core/shell catalyst is at a cathode.

4. The ORR catalyst of claim 1, wherein a shape of the core/shell catalyst is chosen from polyhedral, nanorod, nanowire, nanoplate or nanosheet.

5. The ORR catalyst of claim 1, wherein the core/shell catalyst has a compressive strain ranging from about −0.06 to about 0.00.

6. The ORR catalyst of claim 1, wherein an ORR is performed at a temperature ranging from about 80° C. to about 230° C.

7. A high-temperature polymer electrolyte membrane fuel cell (HT-PEMFC) comprising the ORR catalyst of claim 1 and a phosphoric acid-contained polymer matrix, wherein the phosphoric acid-contained polymer matrix is in physical contact with the ORR catalyst.

8. The HT-PEMFC of claim 7, wherein the phosphoric acid-contained polymer matrix is a phosphoric acid-polybenzimidazole (PA-PBI) or a phosphoric acid-doped ammonium-biphosphate ion pair coordinated polyphenylene (PA-QAPOH).

9. The ORR catalyst of claim 1, wherein the phosphonated ionomer is poly(2,3,5,6-tetrafluorostyrene-4-phosphonic acid) (PWN) or poly(tetraflurostyrene phosphonic acid-copentafluorostyrene).

10. A membrane electrode assembly (MEA), the MEA comprising:
at least one catalyst layer which comprises a core/shell catalyst, and,
a phosphoric acid or a phosphonated ionomer,
the core/shell catalyst comprising a core surrounded by a shell, the core comprising palladium or a palladium-M1 alloy, the shell comprising a platinum-M2 alloy; and,
a phosphoric acid or a phosphonated ionomer contacting the core/shell catalyst, wherein M1 is chosen from scandium, titanium, vanadium, chromium, manganese, iron, cobalt, nickel, copper or zinc; and
M2 is gold or silver.

11. The MEA of claim 10, wherein core/shell catalyst comprises nanoparticles of the core/shell catalyst.

12. The MEA of claim 10, wherein the core/shell catalyst is at a cathode.

13. The MEA of claim 10, further comprising a phosphoric acid-contained polymer matrix in physical contact with the core/shell catalyst.

14. The MEA of claim 13, wherein the phosphoric acid-contained polymer matrix is a phosphoric acid-doped polybenzimidazole (PA-PBI) or a phosphoric acid-doped ammonium-biphosphate ion pair coordinated polyphenylene (PA-QAPOH).

15. The MEA of claim 11, wherein the phosphonated ionomer is poly(2,3,5,6-tetrafluorostyrene-4-phosphonic acid) (PWN) or poly(tetraflurostyrene phosphonic acid-copentafluorostyrene).

16. A membrane electrode assembly (MEA), the MEA comprising:
an anodic catalyst layer;
a cathodic catalyst layer comprising carbon supported cathodic catalyst particles of a core/shell catalyst, and, a phosphoric acid or a phosphonated ionomer; and,
a phosphoric acid-contained polymer matrix mediating protic communication between the anodic catalyst layer and the cathodic catalyst layer,
the core/shell catalyst comprising a core surrounded by a shell, the core comprising palladium or a palladium-M1 alloy, the shell comprising a platinum-M2 alloy; and,
a phosphoric acid or a phosphonated ionomer contacting the core/shell catalyst, wherein M1 is chosen from scandium, titanium, vanadium, chromium, manganese, iron, cobalt, nickel, copper or zinc; and
M2 is gold or silver.

17. The MEA of claim 16, wherein the cathodic catalyst particles are nanoparticles of the core/shell catalyst.

18. The MEA of claim 16, wherein the phosphoric acid-contained polymer matrix is a phosphoric acid-doped polybenzimidazole (PA-PBI) or a phosphoric acid-doped ammonium-biphosphate ion pair coordinated polyphenylene (PA-QAPOH).

19. The MEA of claim 16, wherein the phosphonated ionomer is poly(2,3,5,6-tetrafluorostyrene-4-phosphonic acid) (PWN) or poly(tetraflurostyrene phosphonic acid-copentafluorostyrene).

20. A high-temperature polymer electrolyte membrane fuel cell (HT-PEMFC) comprising the MEA according to claim 16.
